(19) United States
(12) Patent Application Publication
(10) Pub. No.: US 2003/0163604 A1
(43) Pub. Date: Aug. 28, 2003

(54) Method and apparatus for design and manufacturing application feature interoperability

(75) Inventors: Boris Rabinovich, Sudbury, MA (US); Phil J. Abercrombie, Belmont, MA (US)

Correspondence Address: LAHIVE & COCKFIELD, 28 STATE STREET, BOSTON, MA, 02109, US

(73) Assignee: Parametric Technology Corporation, Needham, MA

(21) Appl. No.: 10/085,844

(22) Filed: Feb. 26, 2002

(51) Int. Cl. G06F 9/00; G06F 9/455

(52) U.S. Cl. 709/331

(57) ABSTRACT

A method and apparatus suitable for use with a CAD system that enables communication between a first CAD application and a second CAD application in a manner providing feature interoperability. In at least one electronic device, a method of sharing data between a first computer aided design (CAD) application and a second CAD application is provided. The method includes the first CAD application storing the data in the form of feature information and feature history relating to a modeled object. The second CAD application is provided with access to the feature information and feature history stored by the first CAD application. The second CAD application reads the feature information and the feature history stored by the first CAD application, such that the second application can evaluate, recreate, regenerate, and/or model the modeled object, the feature information, and the feature history.

### RELATED APPLICATION

This application is being filed with counterpart application U.S. Application No. (Attorney Docket PAS-163), filed Feb. 26, 2002, which is hereby expressly and entirely incorporated herein by reference.

### FIELD OF THE INVENTION

The present invention relates to computer aided design applications, and more particularly to the sharing of feature information and feature history between multiple applications.

### BACKGROUND OF THE INVENTION

A computer-aided design (“CAD”) system is a computer implemented tool for engineers and architects to utilize in designing a plethora of structures from products to buildings. The computer portion of the CAD system includes a central processing unit, a display device, such as a computer monitor, and a number of input devices such as, a keyboard, a mouse, a light pen, a digitialising tablet, and the like. The central processing unit has one or more CAD software applications installed thereon.

The CAD software applications allow a user to input and view a design for a particular structure in the form of an object. The user can often rotate the view of the object to any angle, and also zoom in or zoom out for different views and perspectives. Additional visual features such as highlighting, shading, cross-hatching, and the like, enable the user to design an object with the aid of the computing power inherent in the central processing unit. The CAD application can also keep track of, and monitor, design changes to the object in addition to design dependencies. This means that when the user adds or changes an element within the object, other values that depend on that change are automatically updated in accordance with engineering concepts and rules of design.

CAD systems have been in existence for a number of decades. As a result, different CAD systems have been developed utilizing different computer hardware platforms and different computer software applications. Companies that utilize these CAD systems are often in the situation wherein a decision was made in years past to purchase a particular CAD system, and due the expense of changing to a different CAD system, have maintained and continuously updated the original CAD system as updated versions are released from the CAD system manufacturer. It is difficult to change the particular CAD system that a company utilizes in creating their designs, because most often, different CAD systems are not interoperable. Without interoperability, one cannot take a model of a structure created on a first CAD system and simply transfer that modeled object to a second, different, CAD system, without experiencing compatibility issues.

Some CAD systems include the feature of being able to export data relating to a model of an object to another CAD system. To export the data, the model of the object is first reduced to its simple shape. The set of instructions describing how the model was created (i.e., feature information and feature history) are stripped from the model. The simple shape stripped version of the model is then exported to a remote CAD system, or a remote file location. The second CAD system then must read the exported file and translate the data into a compatible format for the second CAD system. This makes it difficult for engineers designing different pieces of a larger structure to utilize different CAD systems on an individual basis. Collaboration between engineers in remote locations using different CAD systems becomes logistically complicated to orchestrate. More importantly, the feature information and the feature history are not accessible or usable by the second CAD system, thus valuable engineering and design information is lost in the export process.

CAD systems can build models of objects based on a feature system. A feature can take the form of a shape, a line, a hole, and the like. CAD models are generated from a set of features. Feature-based CAD systems enable the user to manipulate the CAD models on a feature-by-feature basis. One of ordinary skill in the art will appreciate there can be hundreds of different possible features available in CAD systems. A modeled object is formed with one or more of the features. For example, a modeled object could be formed from a block having six sides, each side being square, and a hole passing through a front side to a back side of the block. In this instance the modeled object is a cube with a hole therethrough. The term feature information as utilized herein relates to information that details each of the features that form a modeled object. In the instant example, the feature information would include dimensions, orientations, and locations of the block feature and the hole feature.

Feature history is a sequence of the different combinations of features utilized in modeling a final modeled object. For example, to make a model of a stop sign, an octagon is required. This can be formed by starting with a square, and chamfering off each of the corners of the square to result in the octagonal shape. The feature history would include the original square, then each consecutive shape as each corner is chamfered off, ending with the octagon.

Therefore, a user of the second CAD system having received an exported object in the conventional manner cannot look back into history of steps that were utilized to form the particular object. This can hinder the development of the object and the overall design because an engineer often requires knowledge of such histories. It also can lead to design flaws, because a change made in a later version of an object in a different CAD program, likely will not be properly translated back to the originating CAD program. Therefore, the overall design cannot reliably be checked for validity of engineering concepts and rules of design.

The ability to share design data as an object is being created and have complete access to feature information and feature history is important when modifying an object. There is often a desire to have the ability to share feature information and feature histories and move such data from one application to another application without loss of histories or other data, so that users of different CAD and other applications can make use of the feature information and feature history.

### SUMMARY OF THE INVENTION

There is a need for a method and apparatus relating to a CAD system that enables communication between a first CAD application and a second CAD application in a manner providing feature interoperability. The present invention is directed toward further solutions to address this need.

In accordance with one embodiment, in at least one electronic device, a method of sharing data between a first computer aided design (CAD) application and a second CAD application is provided. The method includes the first CAD application storing the data in the form of feature information and feature history relating to a modeled object. The second CAD application is provided with access to the feature information and feature history stored by the first CAD application. The second CAD application reads the feature information and the feature history stored by the first CAD application, such that the second application can evaluate, recreate, regenerate, and/or model the modeled object, the feature information, and the feature history.

In accordance with one embodiment of the present invention, storing includes placing native data and a sub-set of native data on a recordable medium. The sub-set of native data results from processing the native data with at least one routine from a first library of executable routines to derive the sub-set of native data. The first library of executable routines is embedded within the first CAD program. Alternatively, the first library of executable routines is a component accessible by the first CAD program.

In accordance with still another embodiment of the present invention, the step of providing access includes providing a plug-in having an application program interface (API) and being accessible by the second CAD application, and conveying at least one of the feature information and the feature history to the plug-in.

In accordance with another aspect of the present invention, native data and a sub-set of native data form the feature information and the feature history.

In accordance with yet another embodiment of the present invention, in at least one electronic device, a method of sharing data between a first computer aided design (CAD) application and a second CAD application is provided. The method includes the second CAD application gaining access to the data relating to feature information and feature history relating to a modeled object. The second CAD application reads the feature information and the feature history stored by the first CAD application, such that the second application can evaluate, recreate, regenerate, and/or model the modeled object, the feature information, and the feature history.

In accordance with one embodiment of the present invention, a plug-in has an application program interface (API) suitable for communicating with the first CAD application and conveying at least one of the feature information and the feature history to the plug-in.

In accordance with still another embodiment of the present invention, a system for modeling an object is provided. The system includes a first CAD application and a second CAD application. Feature information and feature history relating to an object modeled on the first CAD application are stored in a first memory store. A plug-in is accessible by the second CAD application and is suitable for accessing and retrieving the feature information and feature history to enable the second CAD application to create a second model of at least a portion of the object modeled on the first CAD application and be able to evaluate and manipulate the feature information and feature history, without the first CAD application having to export a file containing the object.

In accordance with yet another embodiment of the present invention, in at least one electronic device, a method of communicating between a first application and a second application is provided. The method includes generating feature information and feature history as an object is modeled in the first application. The feature information and feature history are stored. An application program interface (API) is utilized to retrieve the feature information and feature history and convey the feature information and feature history to the second application.

### BRIEF DESCRIPTION OF THE DRAWINGS

The aforementioned features and advantages, and other features and aspects of the present invention, will become better understood with regard to the following description and accompanying drawings, wherein:

FIG. 1 is a diagramatic illustration of a conventional CAD system;

FIG. 2 is a diagrammatic illustration of a CAD application, according to one aspect of the present invention;

FIG. 3 is a diagrammatic illustration of the CAD application of FIG. 2 interacting with a second CAD application, according to one aspect of the present invention;

FIGS. 4A and 4B are flowcharts illustrating methods by which native data can be created and transported, according to one aspect of the present invention;

FIG. 4C is a step-wise progression of the update feature, according to one aspect of the present invention;

FIGS. 5 and 5A, 5B, 5C, and 5D illustrate a flowchart with corresponding diagrammatic illustrations of an example modeled object feature information and feature history being developed, according to one aspect of the present invention;

FIG. 6 is a flowchart showing example steps of an application accessing feature information and feature history, according to one aspect of the present invention; and

FIG. 7 is a flowchart showing example steps of another application accessing feature information and feature history, according to another aspect of the present invention.

### DETAILED DESCRIPTION

An illustrative embodiment of the present invention relates to a method and apparatus providing feature interoperability between two or more design or manufacturing related applications. Each of the design or manufacturing related applications can read each other's native data files to evaluate and create modeled objects. Feature interoperability is realized when an object is modified in one application, and a second application can view feature information and feature history as well as utilize and update the feature information and feature history while further modifying the object.

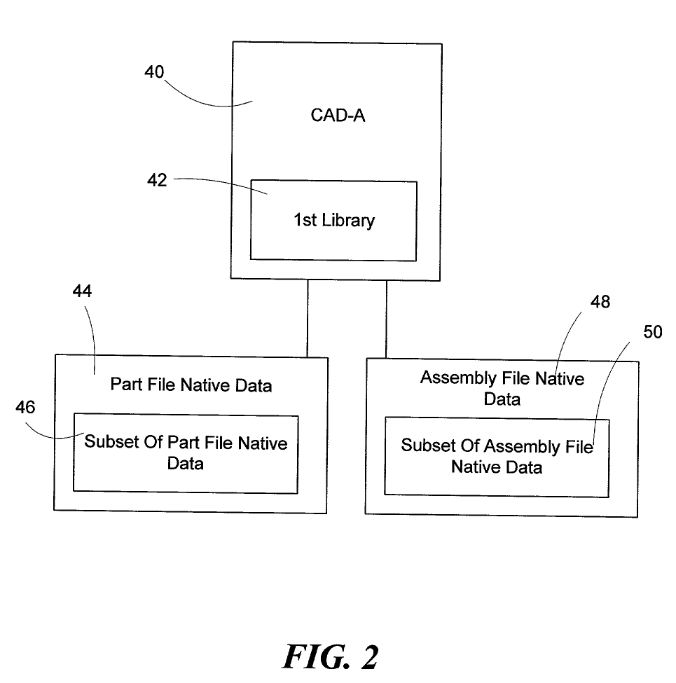

FIGS. 2 through 7, wherein like parts are designated by like reference numerals throughout, illustrate example embodiments of a method and apparatus for providing associative and feature interoperability between engineering and manufacturing design applications according to aspects of the present invention. Although the present invention will be described with reference to the example embodiments illustrated in the figures, many alternative forms can embody the present invention. One of ordinary skill in the art will additionally appreciate different ways to alter the parameters of the embodiments disclosed, such as the size, shape, type of elements, or materials, form of data, type of application or the like, in a manner still in keeping with the spirit and scope of the present invention.

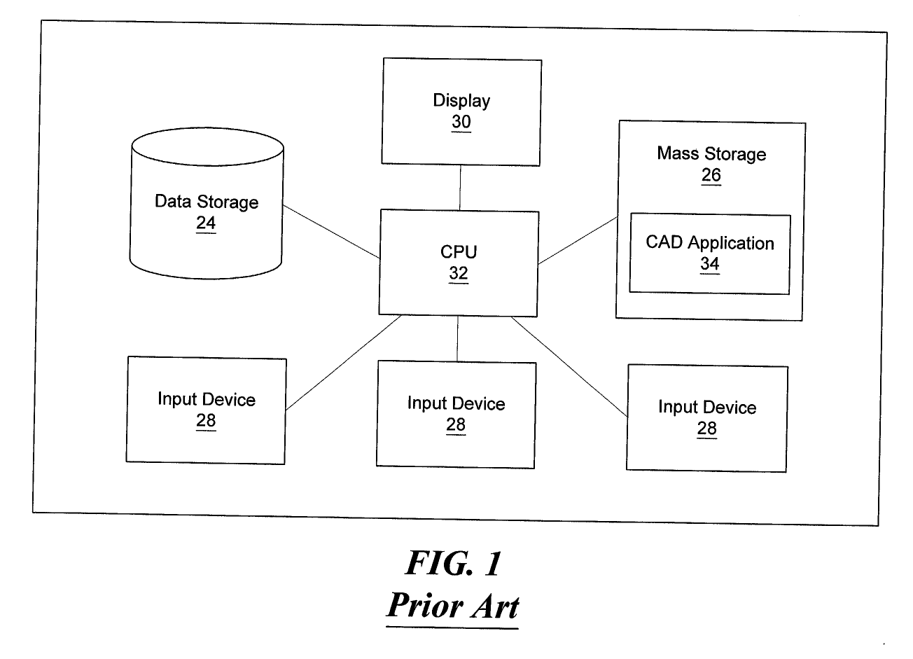

FIG. 1 illustrates a conventional computer aided design (“CAD”) system 20 that can make use of the present invention. The CAD system 20 includes hardware and software components. A computing apparatus 22 forms the hardware portion of the CAD system 20. The computing apparatus 22 is a programmable device that responds to a specific set of instructions in a well defined manner and can execute a set of instructions. The computing apparatus 22 can include a storage device 24, which enables the computing apparatus 22, to store at least temporarily, data, information, and programs (e.g., RAM or ROM). A mass storage device 26 can substantially permanently store data, information, and programs (e.g., a disk drive or tape drive). An input device 28 can be provided through which data and instructions enter the computing apparatus (e.g., a keyboard, mouse, stylus, light pen, or a digitizing tablet). An output device 30 can be provided to display or produce results of computing actions (e.g., display screen, printer, plotter, or infra red, serial, or digital port). A central processing unit (CPU) 32 can include a processor for executing the specific set of instructions.

A CAD application 34 can be installed, or in communication, with the computer apparatus 22 to provide instructions for processing. The CAD application 34 can be used for e.g., engineering, manufacturing, architectural, or other design or manufacturing functions. One of ordinary skill in the art will appreciate that CAD systems in the past have existed in the form of a dedicated hardware device incorporating the CAD functions and unable to perform non-CAD related operations. More recent CAD systems make use of mainframe or personal computer hardware platforms and are embodied in software applications installed thereon.

FIG. 2 shows a diagrammatic illustration of a CAD-A application 40, which is an example embodiment of a CAD application for use in conjunction with the teachings of the present invention. The CAD-A application 40 includes a first library 42 of executable routines. The first library 42 of executable routines enables the manipulation of native data generated by the CAD-A application 40 when an object is modeled. For example, when the CAD-A application 40 models an object, a plurality of files are created. A part-file includes part native data 44 and an assembly file includes assembly native data 48. The part-native data 44 relates to the geometric representation of the part, a set of features that describe how to create the geometric representation of the part, and other information such as annotations, manufacturing information, and dimensional parameters. The assembly native data 48 relates to the location of, and quantities of, parts in an assembly, instructions for placing parts in the proper locations, and different configurations of the assembly.

By native data, what is meant is data in a native file format that is used internally by the CAD-A application 40. When an application stores data, it does so in a native format. One of ordinary skill in the art will appreciate that the illustrated embodiments disclosed herein utilize part native data, assembly native data, sub-sets of part native data, and sub-sets of assembly native data. However, these specific forms of native data are merely examples. The invention is not limited to the specific example forms of native data discussed herein, or to manipulation of data at the native data level. These examples are for illustrative purposes to aid in the explanation of the features of the present invention.

The native data serves, among other things, as the foundation data of the feature information and the feature history. Therefore, below is a discussion of the associative interoperability between two applications. The feature interoperability of the present invention is enabled by two applications having the ability to transport files back and forth at a native data level, or other data level. The associative interoperability described herein is one example of how two or more applications can easily share data and files. However, the feature interoperability of the present invention can be utilized by any collection of applications that have the ability to share data and information.

The executable routines of the first library 42 manipulate the part native data 44 to create a sub-set of part native data 46 and/or a sub-set of assembly native data 50. The sub-set of part native data 46 and the sub-set of assembly native data 50 represent data that has been filtered or otherwise extracted from the part native data 44 and the assembly native data 48 of the CAD-A application 40. The sub-set of part native data 46, and the sub-set of assembly native data 50 comprise a predetermined selection of the native data sufficient to enable another CAD application to evaluate, read, recreate, regenerate, or update a model of an object relating to the object modeled in the CAD-A application 40. For example, the sub-set of part native data 46 and the sub-set of assembly native data 50 include information concerning features, attributes, feature information, and feature history of the object modeled in the CAD-A application 40.

A vendor of the CAD-A application 40 provides the CAD-A application 40 with access to the first library 42. This access can be, for example, in the form of the first library 42 being embedded in the CAD-A application 40, or the first library 42 can be a component accessible by the CAD-A application 40. In addition, the vendor of the CAD-A application 40 may provide a second library in the form of a plug-in 52. The plug-in 52 includes an application program interface (“API”) to enable communication between the CAD-A application 40 and another CAD application as described below. The plug-in 52 includes at least one executable routine suitable for accessing the part native data 44 and the assembly native data 48 to extract the sub-set of part native 46 and the sub-set of assembly native data 50.

A plug-in, as utilized herein, is a hardware or software module that adds a specific feature or service to a larger system. A single module can contain one or more executable routines. Plug-ins can be used dynamically by an application. Instances of plug-ins include DLLs, virtual machine bytecode, scripts, web services, and the like.

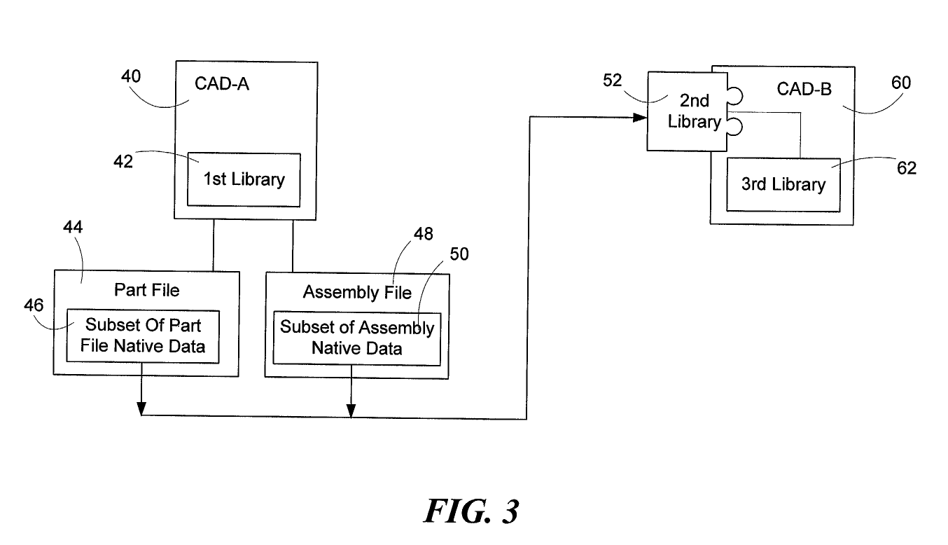

FIG. 3 is a diagrammatic illustration of the CAD-A application 40 associatively interoperating with another CAD application, CAD-B application 60. The CAD-B application 60 includes a third library 62 of executable routines. The plug-in 52, provided by the vendor of the CAD-A application 40 is optionally provided to the CAD-B application 60. One of ordinary skill in the art will appreciate that the first library 42 of executable routines and the third library 62 of executable routines can be instances of a same collection of executable routines.

In operation, when a model of an object is created on the CAD-A application 40, the part native data 44 and the assembly native data 48 are generated and stored. The sub-set of part native data 46 and the sub-set of assembly native data 50 can be generated by the first library 42 of executable routines at the time that the part native data 44 and the assembly native data 48 are generated. Alternatively, the sub-set of part native data 46, and the sub-set of assembly native data 50 can be generated with a filtering process executed by the plug-in 52 when the sub-sets of native data 46 and 50 are requested by the CAD-B application 60. In either instance, if the CAD-B application 60 requires information relating to the object modeled on the CAD-A application 40, the CAD-B application 60 utilizes the plug-in 52 to access the part native data 44 and the assembly native data 48 to retrieve the sub-set of part native data 46 and the sub-set of assembly native data 50.

Once the sub-set of part native data 46 and the sub-set of assembly native data 50 arrive at the CAD-B application 60, the third library 62 of executable routines are utilized by the CAD-B application 60 to recreate, regenerate, or otherwise model at least a portion of the object as originally modeled in the CAD-A operation 40. The associative interoperability is achieved in this example configuration by the provision of the plug-in 52 by each vendor making an application such as the CAD-A application 40 for creating models of objects or otherwise manipulating the modeled objects. However, the feature interoperability as provided by the present invention is not restricted to using only the associatively interoperable configuration described above. This configuration is provided as one example implementation that can work in conjunction with the feature interoperability of the present invention.

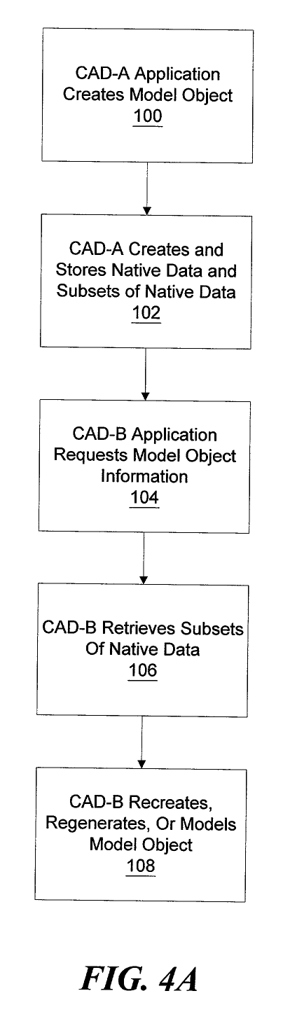

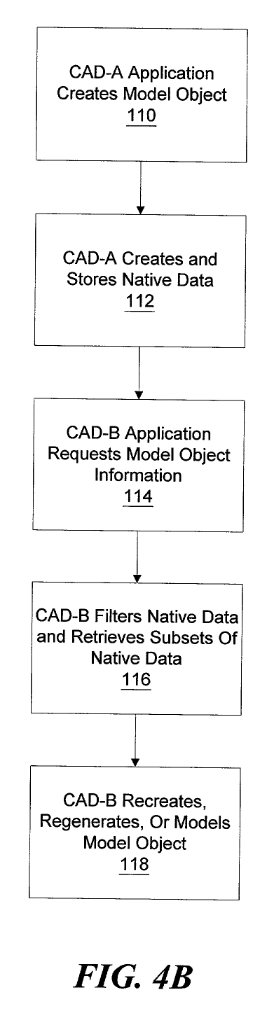

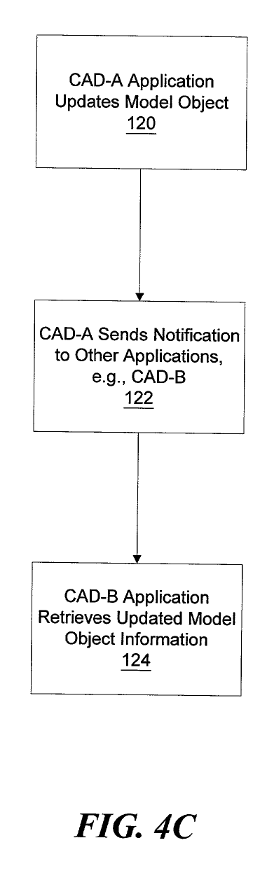

FIGS. 4A and 4B are flowcharts illustrating two possible methods by which the required sub-sets of native data can be created and transported. In FIG. 4A, a model of an object is created on the CAD-A application 40 (step 100). The part native data 44 and the assembly native data 48 are generated and stored, and the sub-set of part native data 46 and the sub-set of assembly native data 50 are generated by the first library 42 of executable routines and stored (step 102). Thus, the part native data 44, the assembly native data 48, the sub-set of part native data 46, and the sub-set of assembly native data 50 all are in existence on one or more storage mediums. The CAD-B application 60 requests information relating to the object modeled on the CAD-A application 40 (step 104). The CAD-B application 60 accesses the part native data 44 and the assembly native data 48 to retrieve the sub-set of part native data 46 and the sub-set of assembly native data 50 (step 106). This access can be accomplished utilizing the plug-in 52, or by alternative method in a different configuration. The third library 62 of executable routines are utilized by the CAD-B application 60 to evaluate, read, recreate, regenerate, or otherwise model at least a portion of the object as originally modeled in the CAD-A operation 40 (step 108).

In FIG. 4B, a model of an object is created on the CAD-A application 40 (step 110). The part native data 44 and the assembly native data 48 are generated and stored (step 112). The CAD-B application 60 requests information relating to the object modeled on the CAD-A application 40 (step 114). The sub-set of part native data 46, and the sub-set of assembly native data 50 are generated with a filtering or translation process and transferred to the CAD-B application (step 116). The sub-set of part native data 46 and the sub-set of assembly native data 50 in this example are not pre-existing when the CAD-B application 60 requests the information. Again, the filtering and/or translation process can be executed by the plug-in 52 in the example configuration, or by another means in an alternate configuration. The third library 62 of executable routines is utilized by the CAD-B application 60 to evaluate, read, recreate, regenerate, or otherwise model at least a portion of the object as originally modeled in the CAD-A operation 40 (step 118).

FIG. 4C shows a step-wise progression of the update feature described previously. An object having been communicated from the CAD-A application 40 to the CAD-B application 60 will often be updated at a point in time subsequent to the transfer of the sub-set of part native data 46 and the sub-set of assembly native data 50. When the CAD-A application 40 updates the object (step 120), the CAD-A application can send a notification to other applications such as the CAD-B application 60 that an update was made (step 122). The CAD-B application 60 can then read the updated sub-set of part native data 46 information and the updated sub-set of assembly native data 50 information (step 124) to ensure that the object on the CAD-B application 60 is consistent with the CAD-A application 40. Likewise, when a change is made to the object in the CAD-B application 60, the CAD-B application can issue notifications to other applications that a change has been made and an update is required.

As previously mentioned, the above description is merely one approach allowing multiple applications and/or systems to interact with one another in a manner enabling the sharing of data. Below is a description of how the present invention makes use of the ability to share data to convey feature information and feature history from one application or system to another.

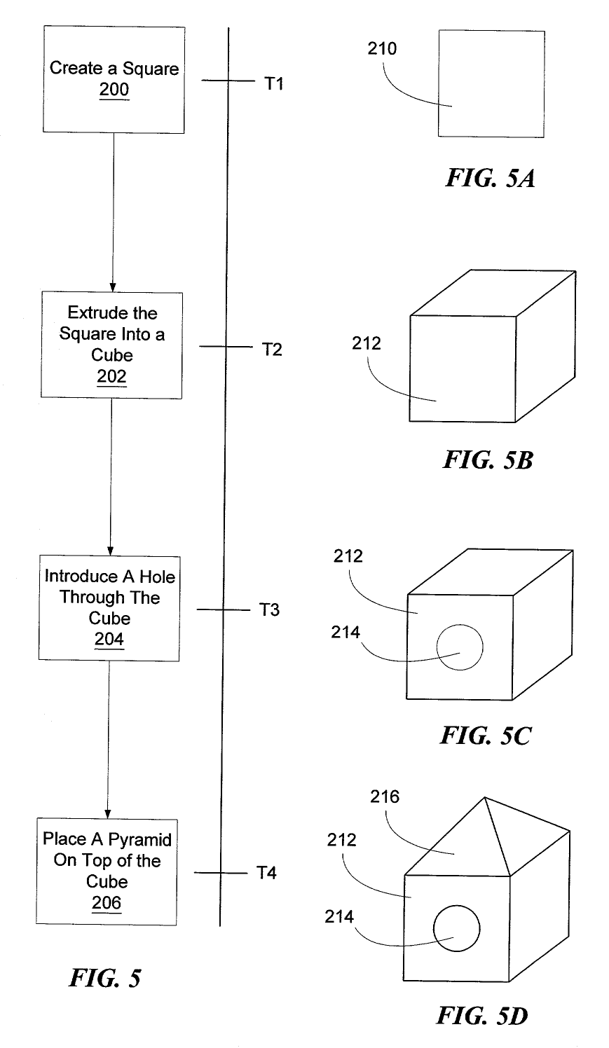

FIG. 5 is a flowchart illustrating the progression of steps as a modeled object is formed. FIGS. 5A through 5D show the modeled object as it is formed on, for example, a visual display of a CAD application. The flowchart describes the steps that a designer might take in creating the modeled object that results in FIG. 5D.

To begin, at time T1, a square 210 is created (step 200) having specified dimensions, location, and orientation. The square 210 is extruded into a cube 212 (step 202) at time T2. A hole 214 is introduced having specified dimensions, location, and orientation through the cube 212 (step 204) at time T3. A pyramid 216 is then placed atop the cube 212 (step 206) at time T4. The type, dimensions, location, and orientation, among other attributes, make up the feature information for the modeled object of FIG. 5D. The feature history includes each of the steps between time T1 and time T4 as the final modeled object of FIG. 5D is created.

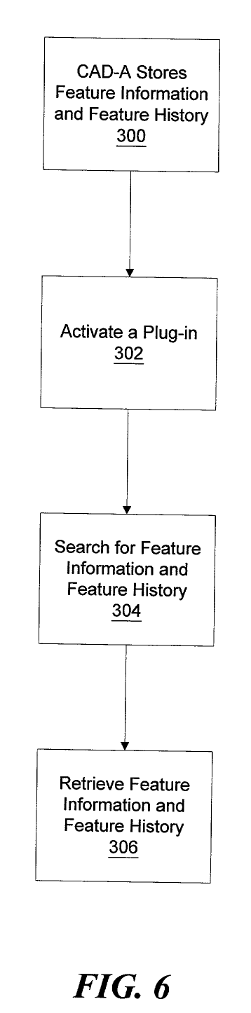

FIG. 6 is a flowchart showing the CAD-B application 60 accessing the CAD-A application 40 to retrieve desired feature information and feature history. First, the CAD-A application 40 stores the feature information and the feature history (step 300). If a user of the CAD-B application 60 wants to obtain a model of the modeled object of FIG. 5D, the CAD-B application 60 activates a plug-in (step 302). The plug-in is provided by the CAD-A application 40. The CAD-B application 60 searches for the feature information and the feature history of the model (step 304). Upon locating the feature information and the feature history, the CAD-B application retrieves the feature information and feature history (step 306). The CAD-B application 60 then has access to the feature information and feature history to utilize, evaluate, recreate, regenerate, and/or model the modeled object, the feature information, and the feature history in whatever manner desired. For example, the CAD-B application 60 may wish to look back in time to time T3 to determine how the hole 214 was introduced. Alternatively, the CAD-B application 60 may investigate the origin of the pyramid 216 in combination with the cube 212 at time T4, or see what the cube looked like originally, at time T2.

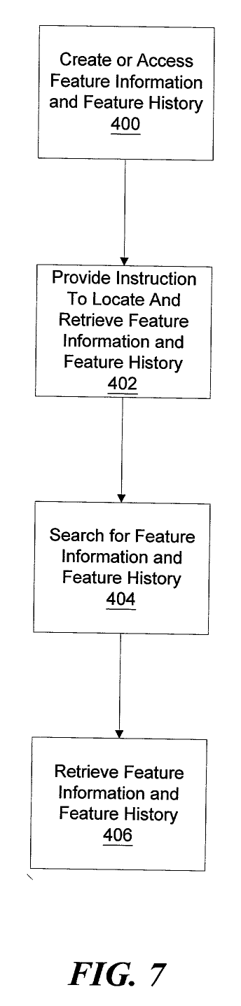

FIG. 7 is a flowchart illustrating another embodiment wherein the feature information and feature history can be conveyed between different applications. To begin, a first application stores feature information and feature history of a modeled object (step 400). If a user of a second application is desirous of obtaining a model of the modeled object, the user instructs the second application to locate and retrieve the feature information and feature history of the modeled object (step 402). The second application searches for the feature information and the feature history of the modeled object (step 404). Upon locating the feature information and the feature history, the second application retrieves the feature information and feature history (step 406). The second application 60 then has gained access to the feature information and feature history to utilize, evaluate, recreate, regenerate, and/or model the modeled object, the feature information, and the feature history, as desired.

The system and method of the present invention enables various applications provided by multiple vendors to offer feature interoperability. The present invention enables more reliable modeling in that the feature information and feature history of different modeled objects can not only be accessed, but subsequently modified and utilized by a number of different applications from different vendors. This feature interoperability provides for a more user-friendly CAD system, and a more useful tool for enabling the design of a modeled object from different locations and using different applications. The feature interoperability allows different CAD systems having the ability to share files or access common files to continuously modify a modeled object design, and receive updates from other applications and/or systems.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure and method may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. In at least one electronic device, a method of sharing data between a first computer aided design (CAD) application and a second CAD application, comprising:
the first CAD application storing the data in the form of feature information and feature history relating to a modeled object;
providing the second CAD application with access to the feature information and feature history stored by the first CAD application; and
the second CAD application reading the feature information and the feature history stored by the first CAD application, such that the second application can at least one of one of evaluate, recreate, regenerate, and model the modeled object, the feature information, and the feature history.

2. The method of claim 1, wherein storing comprises placing native data and a sub-set of native data on a recordable medium.

3. The method of claim 2, wherein the sub-set of native data results from processing the native data with at least one routine from a first library of executable routines to derive the sub-set of native data.

4. The method of claim 3, wherein the first library of executable routines is embedded within the first CAD program.

5. The method of claim 3, wherein the first library of executable routines is a component accessible by the first CAD program.

6. The method of claim 1, wherein providing access comprises providing a plug-in having an application program interface (API) and being accessible by the second CAD application, and conveying at least one of the feature information and the feature history to the plug-in.

7. The method of claim 6, wherein native data and a sub-set of native data form the feature information and the feature history.

8. In at least one electronic device, a method of sharing data between a first computer aided design (CAD) application and a second CAD application, comprising:
the second CAD application gaining access to the data relating to feature information and feature history relating to a modeled object; and
the second CAD application reading the feature information and the feature history stored by the first CAD application, such that the second application can at least one of one of evaluate, recreate, regenerate, and model the modeled object, the feature information, and the feature history.

9. The method of claim 8, further comprising the first CAD application placing native data and a sub-set of native data on a recordable medium.

10. The method of claim 9, wherein the sub-set of native data results from processing the native data with at least one routine from a first library of executable routines to derive the sub-set of native data.

11. The method of claim 10, wherein the first library of executable routines is one of embedded within the first CAD program and a component accessible by the first CAD program.

12. The method of claim 11, wherein a plug-in has an application program interface (API) suitable for communicating with the first CAD application and conveying at least one of the feature information and the feature history to the plug-in.

13. The method of claim 12, wherein native data and a sub-set of native data form the feature information and the feature history.

14. A system for modeling an object, comprising:
a first CAD application;
a second CAD application;
feature information and feature history relating to an object modeled on the first CAD application stored in a first memory store;
a plug-in accessible by the second CAD application and suitable for accessing and retrieving the feature information and feature history to enable the second CAD application to create a second model of at least a portion of the object modeled on the first CAD application and be able to evaluate and manipulate the feature information and feature history without the first CAD application having to export a file containing the object.

15. In at least one electronic device, a method of communicating between a first application and a second application, comprising:
generating feature information and feature history as an object is modeled in the first application;
storing the feature information and feature history; and
utilizing an application program interface (API) to retrieve the feature information and feature history and convey the feature information and feature history to the second application.

16. A computer readable medium containing software suitable for executing a method of sharing data between a first computer aided design (CAD) application and a second CAD application, the method comprising:
the first CAD application storing the data in the form of feature information and feature history relating to a modeled object;
providing the second CAD application with access to the feature information and feature history stored by the first CAD application; and
the second CAD application reading the feature information and the feature history stored by the first CAD application, such that the second application can at least one of one of evaluate, recreate, regenerate, and model the modeled object, the feature information, and the feature history.

17. A computer readable medium containing software suitable for executing a method of sharing data between a first computer aided design (CAD) application and a second CAD application, the method comprising:
the second CAD application gaining access to the data relating to feature information and feature history relating to a modeled object; and
the second CAD application reading the feature information and the feature history stored by the first CAD application, such that the second application can at least one of one of evaluate, recreate, regenerate, and model the modeled object, the feature information, and the feature history.

18. A computer readable medium containing software suitable for executing a method of communicating between a first application and a second application, the method comprising:
generating feature information and feature history as an object is modeled in the first application;
storing the feature information and feature history; and
utilizing an application program interface (API) to retrieve the feature information and feature history and convey the feature information and feature history to the second application.
